(19) United States
(12) Patent Application Publication
(10) Pub. No.: US 2005/0062658 A1
(43) Pub. Date: Mar. 24, 2005

(54) Roof for motor vehicles

(75) Inventors: Christian Michael Magg, Garching (DE); Peter Karl Prassmayer, Grosskarolinenfeld (DE); Frank Mierke, Rosenheim (DE)

Correspondence Address: NIXON & VANDERHYE, PC, 1100 N GLEBE ROAD, 8TH FLOOR, ARLINGTON, VA, 22201-4714, US

(73) Assignee: Kathrein-Werke KG, Rosenheim (DE)

(21) Appl. No.: 10/499,363

(22) PCT Filed: May 8, 2003
(86) PCT No.: PCT/EP03/04843

(30) Foreign Application Priority Data
May 16, 2002 (DE) 102 21 877.3

(51) Int. Cl. H01Q 1/32

(52) U.S. Cl. 343/711

(57) ABSTRACT

The invention concerns a space craft, such as a telecommunication geostationary satellite, comprising a body, at lease one main telecommunication antenna having a specific orientation relative to the body, at least an onmidirectional antenna having a field of view opposite to that of the main antennae and at least a radiator extensible by tilting about an axis linked to the craft body between a slowing position wherein it is pressed against the body and an extended position. Said axis is positioned substantially in the plane of one surface of the body parallel to the orientation of the omnidirectional antenna and to the surfaces or the surface bearing the main antenna. The radiator tilts at an angle close to 180 o from a position wherein it is pressed against one surface bearing a solar panel to a position wherein it extends substantially in the plane of the surface which bears it when it is slowed.

The invention relates to an antenna arrangement as claimed in the precharacterizing clause of claim 1.

An antenna arrangement of this generic type has been disclosed, for example, in DE 201 11 229 U 1. This prior publication describes an antenna arrangement for motor vehicles which has a chassis above which a printed circuit board is arranged, to be precise in order to accommodate circuit components. One or more vertically projecting antenna elements, which is or are at least partially flat, is or are provided vertically with respect to the printed circuit board, which is aligned essentially horizontally, to be precise in order to receive different services or for different frequencies in the mobile radio band.

The entire antenna arrangement is covered by a shroud which may have a shape similar to a fin. Antennas such as these are normally fitted to the motor vehicle bodywork plate, for example at the junction between the motor vehicle roof and the rear windshield.

A multiple frequency antenna arrangement in particular for motor vehicles having a corresponding shroud has been disclosed in EP 0 862 239 A1. By way of example, two printed circuit boards, which are aligned vertically and are offset laterally transversely with respect to the vertical plane are provided in the housing, which is in the form of a shroud, for accommodation of the electronic components. A connecting adapter is provided at the upper end of the housing, that is to say at the uppermost point of the shroud, in order to make it possible to attach an antenna in the form of a whip antenna there.

An antenna which can preferably be used for cars has likewise been disclosed in DE 694 19 080 C2. This antenna also has a housing in the form of a shroud, at whose uppermost projection point a connecting point is provided for a whip antenna. One or more printed circuit board elements, which are aligned vertically or horizontally, can be arranged within the antenna housing. In one embodiment, these printed circuit board elements are likewise arranged parallel to one another and are arranged alongside one another transversely with respect to the plane of the printed circuit board, to be precise aligned transversely with respect to the vehicle longitudinal axis. However, they may also likewise be arranged with a lateral offset parallel to one another, to be precise aligned longitudinally with respect to the vehicle axis.

Furthermore, antenna arrangements are also known in which the printed circuit board which has been mentioned is first of all provided with electronic circuitry components, filter circuits etc. formed on a more or less horizontal chassis, and the antenna elements are once again positioned vertically at right angles to this, in the vertical direction. These antenna elements may, for example, not only be composed of metalically conductive self-supporting antenna element devices but, for example, may likewise once again be formed from a printed circuit board element, that is to say in general from a dielectric material, on which metalized surfaces are provided in order to form the antenna elements.

If the aim is now to receive in only one frequency band range, then one antenna element is sufficient. If the aim is to provide two or more services or one service more than once, or if the aim is, for example, to communicate in various frequency bands in the mobile radio range, then, of course, two or more antenna elements are provided, which are offset with respect to one another or are flat.

The object of the present invention, against the background of this prior art, is to provide a further improved antenna arrangement which, in principle, hes good antenna characteristics with reduced production and material costs overall.

According to the invention, the object is achieved on the basis of the features specified in claim 1. Advantageous refinements of the invention are specified in the dependent claims.

It has now surprisingly been found that there is no need for a horizontal, separate printed circuit board with the matching circuit required for the antenna. Specifically, according to the invention, one or more printed circuit boards are used, which are preferably aligned alongside one another vertically on a common plane and are provided adjacent to the at least one antenna element. The appropriate components for a radio-frequency circuit, which may possibly be provided, are, for example, accommodated on this vertically aligned printed circuit board.

According to the invention, the use of a vertically aligned printed circuit board once again allows the overall design of a corresponding antenna arrangement to be simplified considerably. One surprising feature of this embodiment is that the vertically aligned printed circuit board, which rests on the antenna element at the side, does not influence the antenna polar diagram disadvantageously in the manner which would intrinsically be expected.

The solution according to the invention is distinguished inter alia in that, in contrast to the prior art, the at least one antenna element arrangement is not provided above the printed circuit boards but at the side, alongside this at least one printed circuit board. This prevents any disadvantageous influence on the polar diagram characteristic. This is also particularly surprising, and is not obvious, because an antenna such as this with as broad a bandwidth as possible for the mobile radio field is designed for wavelengths in the range from around 15 cm to 30 cm, so that the size of the vertically arranged printed circuit board is in the range that is relevant for these wavelengths.

Furthermore, it is preferably possible to provide only a single printed circuit board on which not only the radio-frequency circuit which may possibly be provided is accommodated but on which, for example, flat conductive sections can then also be formed on other section areas, forming the relevant antenna element. In this case, widely differing geometric shapes are possible to form the antenna element, for example including whip embodiments, which have a vertically running, flat antenna section, which merges at the top into, for example, an antenna section at the rear.

If, by way of example, a further antenna element is intended to be provided for a second frequency band for the mobile radio area, or in order to provide further services, then this likewise can preferably be provided as a flat antenna element in an area of the printed circuit board that is offset with respect to the first antenna element. However, in precisely the same way, it is also possible to use a further printed circuit board element, which is located on the same plane as the first printed circuit board element or, for example, is offset laterally parallel to it, in order to accommodate the at least one further antenna element here.

Thus, overall, the antenna elements and the radio-frequency circuit which may possibly be provided can be accommodated in a preferred manner on a single, common printed circuit board arrangement.

A cap, which is used for mechanical retention, is required only for installation on the motor vehicle and for mechanical anchoring of the printed circuit board and of the antenna elements located on it.

Further advantages, details and features of the invention will become evident from the “described exemplary embodiments” in the following text. In this case, in detail:

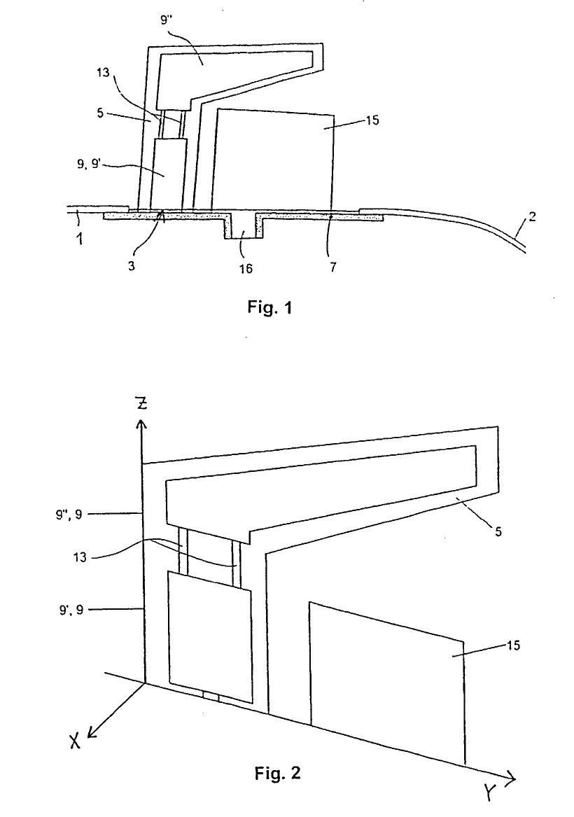

FIG. 1: shows a schematic side illustration of an antenna arrangement with a printed circuit board which runs at the side of it on a common plane in the vertical direction;

FIG. 1a: shows an exemplary embodiment corresponding to FIG. 1, but with the difference that this relates to roof mounting;

FIG. 1b: shows an exemplary embodiment which is once again modified from that shown in FIGS. 1 and 1a, in which the antenna arrangement is mounted with a modified base at the upper edge of a rear windshield;

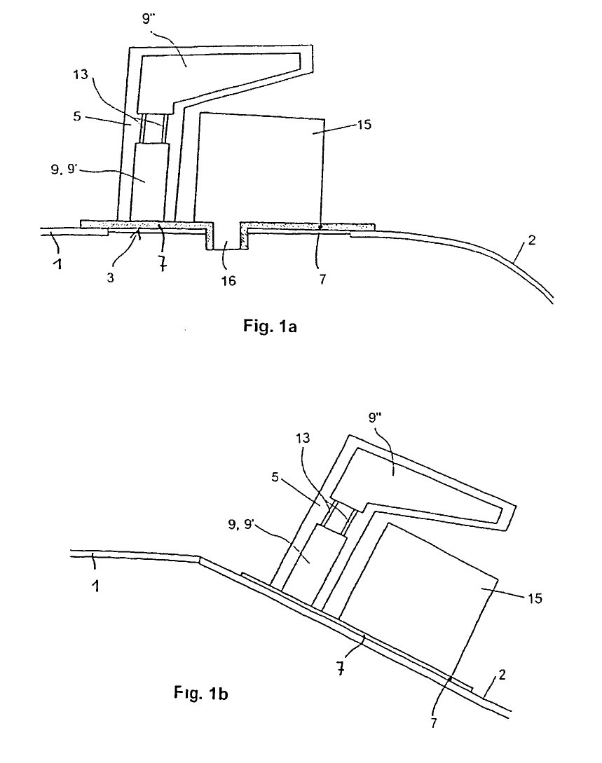

FIG. 2: shows a schematic perspective illustration of the exemplary embodiment shown in FIG. 1; and

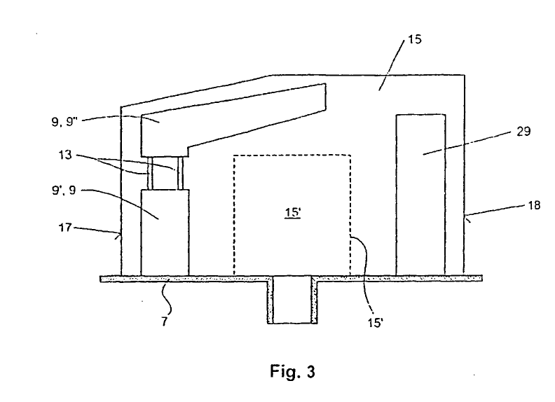

FIG. 3: shows a side illustration of a further modified exemplary embodiment of a printed circuit board with an antenna element located on it.

FIG. 1 shows a schematic side illustration, of a motor vehicle bodywork plate 1, for example at the rear end of the roof, at the junction to a rear window 2, illustrated schematically from the side.

With the opening 3 in the bodywork plate 1 having an appropriately large size, a cap plate or base plate 7 with a printed circuit board 5 that is aligned vertically with respect to it and has electrically conductive surface sections 9′ on it is mounted from underneath on the bodywork plate 1, thus forming an antenna element arrangement 9. The flat elements 9′ are in this case normally aligned in the vehicle longitudinal direction. The entire antenna element arrangement 9 is normally fitted on the line of symmetry of the motor vehicle.

In the illustrated exemplary embodiment, the antenna element arrangement 9 (starting from the lower cap plate or base plate 7 which is arranged essentially horizontally or at a slight angle to the horizontal on the motor vehicle bodywork plate 1) comprises a vertically running first flat section 9′, to which a whip antenna section 9″, which extends to the rear, can then be connected. In the illustrated exemplary embodiment, both antenna sections 9′ and 9″ are electrically connected to one another via a combination comprising an inductance and capacitance 13.

A printed circuit board 15 is provided on the same plane, directly adjacent to the antenna element arrangement 9, that is to say in the illustrated exemplary embodiment in the same vertical plane on the first antenna element section 9′ which extends vertically, on which the radio-frequency circuit of the antenna arrangement, which may possibly be provided, is accommodated. In other words, all of the necessary electrical components and assemblies, filter modules, etc. are seated on this printed circuit board section 15.

The corresponding connecting cables can then be introduced into the motor vehicle interior through an opening 16, which may possibly be provided in the cap plate or base plate 7. This is not illustrated in any more detail in the second exemplary embodiment.

FIG. 2 shows the corresponding arrangement once again, illustrated schematically in perspective form, showing the three spatial coordinates X, Y and Z, in order to illustrate the perspective.

In the exemplary embodiment shown in FIG. 3, the entire arrangement is provided on a common printed circuit board 15. In other words, the flat antenna element 9 with the two flat antenna element sections 9′, 9″ and the combination comprising the inductance and capacitance 13, is provided on this common printed circuit board 15, running in the motor vehicle direction, that is to say in the exemplary embodiment illustrated in the drawing, on the front side 17 on the left, for example by means of appropriate metalization formed on the printed circuit board 15.

The radio-frequency circuit which may possibly be provided is then in turn accommodated, with the appropriate components and parts, in a space 15′ which, for example, is bounded by a rectangular shape.

In the exemplary embodiment shown in FIG. 3, a second antenna element arrangement 29, for example in the form of a metalized surface, is also provided on the common, vertically aligned printed circuit board 15, in the rear area 18 of the printed circuit board 15. The radio-frequency circuit which may possibly be provided for the two antenna element arrangements 9, 29 in the printed circuit board section 15′ is accommodated or the common printed circuit board 15 between the two antenna element arrangements 9, 29.

In contrast to the exemplary embodiment illustrated in FIG. 3, the antenna element arrangements 9 and 29 may, of course, be formed separately from the printed circuit board 15. However, in this exemplary embodiment as well, the printed circuit board 15 will preferably be located aligned vertically immediately at the side between the two antenna element arrangements 9, 29.

As mentioned, the entire arrangement is held mechanically by means of the cap or the so-called base plate 7.

If required, certain sections on the printed circuit board 15 may also be omitted or knocked out, if, for example, it is intended to accommodate an antenna element there which, in contrast to the illustrated exemplary embodiment, is not aligned vertically, for example in the case of a GPS antenna.

As a supplement to the illustrated and described FIG. 1, a further FIG. 1a is also illustrated, with the major difference between FIG. 1a and FIG. 1 being that the exemplary embodiment shown in FIG. 1a relates to roof mounting. In other words, the cap plate or base plate 7 is thus generally mounted on the bodywork roof from above on the bodywork plate 1, so that the cap plate or base plate 7 covers the opening 3.

The exemplary embodiment shown in FIG. 1b uses a different type of base plate or cap plate 7, by means of which the antenna arrangement can also be mounted on a glass pane, for example on a rear windshield of a motor vehicle, preferably at the upper edge in the vicinity of the junction with the bodywork roof. An appropriate protective shroud, which is not illustrated in any more detail, is also fitted in all cases, and covers and protects the entire illustrated antenna arrangement.

1. An antenna arrangement for a motor vehicle, bodywork plate, comprising:
a mounting cap,
at least one antenna element arrangement which extends on a first vertically running plane,
a printed circuit board, arranged such that it runs vertically, said printed circuit board having a radio-frequency circuit with electrical assemblies and/or components,
a protective shroud,
the at least one antenna element arrangement comprising a conductive or metalized surface on a vertically aligned printed circuit board or on a dielectric mount material,
the at least one antenna element arrangements extending from the lower mounting cap in the vertical direction,
the printed circuit board and the at least one antenna element arrangement being arranged parallel to one another or lying on a common plane, and
the printed circuit board or a section of the printed circuit board which surrounds the electrical assemblies and components being arranged laterally alongside one another when viewed transversely with respect to the antenna element arrangement.

2. The antenna element arrangement as claimed in claim 1, wherein the at least one antenna element arrangement has antenna element sections which are aligned at an angle to one another and lie on a common plane.

3. The antenna arrangement as claimed in claim 2, wherein the upper antenna element section is aligned in the direction behind the antenna element section which is located at a lower level and is located above the printed circuit board, or at least that section of the printed circuit board on which electronic components are provided.

4. The antenna element arrangement as claimed in claim 1, wherein at least one second antenna element arrangement is provided, which is offset with respect to the first antenna element arrangement and lies on the same vertical plane as the first antenna element arrangement preferably on a common vertical plane with the first antenna element arrangement.

5. The antenna element arrangement as claimed in claim 1, wherein the area of the printed circuit board which accommodates the electronic assemblies, or the printed circuit board overall, is provided between the two antenna element arrangements.

6. The antenna element arrangement as claimed in claim 1, wherein the at least one antenna element arrangement as well as the printed circuit board or at least a section on the printed circuit board are designed to accommodate electronic components as separate assemblies, which are preferably arranged offset with respect to one another on a common vertical plane.

7. The antenna element arrangement as claimed in claim 1, wherein the at least one antenna element arrangement as well as the section for accommodation of electrical components are formed on a common printed circuit board.

8. The antenna element arrangement as claimed in claim 1, wherein the printed circuit board has apertures or knocked-out sections in order to accommodate additional antenna elements in this area.

9. The antenna element arrangement as claimed in claim 1, wherein the mounting cap rests in the form of a roof mounting, preferably by its edge section, at least indirectly on the bodywork plate.

10. The antenna element arrangement as claimed in claim 2, wherein the antenna element arrangement is connected in the form of a flush mounting, preferably by means of its edge section, at least indirectly to the bodywork plate.

11. The antenna element arrangement as claimed in claim 1, wherein the mounting cap is mounted on a glass pane, preferably in the area of the upper edge of the rear windshield.

12. A mobile antenna comprising:
a substrate that, in use, is vertically aligned, said substrate having radio frequency components thereon;
an antenna element comprising a conductive radiator surface, wherein the substrate and conductive radiator surface are arranged laterally alongside one another when viewed transversely with respect to the antenna element;
a mounting cap supporting said antenna element in the vertical direction; and
a protective shroud protecting said antenna element and said substrate.
